(19) United States
(12) Patent Application Publication
(10) Pub. No.: US 2016/0012754 A1
(43) Pub. Date: Jan. 14, 2016

(54) THREE-DIMENSIONAL MAP DISPLAY DEVICE

(71) Applicant: GEO TECHINICAL LABORATORY CO., LTD., Fukuoka-shi (JP)

(72) Inventors: Kiyonari KISHIKAWA, Fukuoka-shi (JP); Eiji TESHIMA, Fukuoka-shi (JP); Masatoshi ARAMAKI, Fukuoka-shi (JP); Masashi UCHINOUMI, Fukuoka-shi (JP); Masaru NAKAGAMI, Fukuoka-shi (JP); Tatsuya AZAKAMI, Fukuoka-shi (JP)

(21) Appl. No.: 14/859,066

(22) Filed: Sep. 18, 2015

Related U.S. Application Data
(63) Continuation of application No. PCT/JP2014/005130, filed on Mar. 18, 2014.

(30) Foreign Application Priority Data
Mar. 21, 2013 (JP) 2013-057498

(51) Int. Cl. G09B 29/00

(52) U.S. Cl. CPC G09B 29/007; G09B 29/005; G09B 29/008

(57) ABSTRACT

A three-dimensional map effectively uses a space of the sky or the background to display character strings. A transmitter/receiver obtains map data used to display each feature three-dimensionally and character data representing a character string to be displayed in the three-dimensional map from a map database. A feature image generator generates a feature image in which each feature is drawn three-dimensionally. A character display controller controls display of the character string on the feature image. The character display controller changes over at least one of a display direction and a number of display lines of the character string with respect to each of a plurality of areas in the feature image specified according to a distance from a viewpoint set for generating the feature image, such that a length of the character string in a vertical direction increases with a decrease in distance from the viewpoint.

### CLAIM OF PRIORITY

This application is a Continuation of International Patent Application No. PCT/JP2014/001530, filed on Mar. 18, 2014, which claims priority to Japanese Patent Application No. 2013-057498, filed on Mar. 21, 2013, each of which is hereby incorporated by reference.

### BACKGROUND OF THE INVENTION

1. Field of the Invention

The present invention relates to a technology of displaying a character string on a three-dimensional map in which features are expressed three-dimensionally.

2. Description of the Related Art

Three-dimensional maps in which features such as buildings and roads are expressed three-dimensionally have conventionally become popular in navigation systems and other map display devices. The three-dimensional maps include a bird's eye view looking down obliquely from a viewpoint above and an upward view looking up from a viewpoint near to the ground surface.

Like a two-dimensional map, character strings representing, for example, geographical names and feature names are displayed in the three-dimensional map. Displaying a large number of character strings in the map, however, increases the complexity of the resulting map. Various techniques have accordingly been proposed for the map display device to prevent a plurality of character strings from overlapping each other in the bird's eye view. For example, in response to detection of a possibility that a plurality of character strings overlap each other, techniques described in Japanese Patent Laid-Open Application Nos. JP 2003-30687A and JP H11-311527A reduce the number of character strings to be displayed or reduce the font size of characters, in order to avoid the plurality of character strings from overlapping each other. Another technique displaces the display position of a character string from a specified position, in order to avoid the plurality of character strings from overlapping each other.

### BRIEF DESCRIPTION OF THE INVENTION

Simply reducing the number of character strings to be displayed over the entire area in the three-dimensional map, however, reduces the volume of map information in the three-dimensional map. Simply reducing the font size of characters makes it difficult to recognize the characters. Displacement of the display position of the character string from the specified position makes it difficult to understand the relation between the character string and the feature.

The three-dimensional map, on the other hand, includes a relatively large space for displaying the sky as the background, in addition to the space for displaying features. The effective use of such a space of the sky or the background for display of character strings has not been fully considered in the conventional three-dimensional maps. The bird's eye view especially includes a wide area of such excess space.

In order to solve the problems described above, an object of the invention is to effectively use the space of the sky or the background for display of character strings in a three-dimensional map. The invention may be implemented by any of the following aspects and embodiments, in order to solve at least part of the above problems.

According to one aspect, there is provided a three-dimensional map display device that displays a three-dimensional map in which features are expressed three-dimensionally. The three-dimensional map display device comprises: a map database that stores map data used to display each feature three-dimensionally, in relation to character data representing a character string to be displayed in the three-dimensional map; a feature image generator that uses the map data to generate a feature image by perspective projection of each feature from a specified viewpoint; and a character display controller that uses the character data to control display of the character string on the feature image. The character display controller changes over at least one of a display direction and a number of display lines of the character string with respect to each of a plurality of areas in the feature image specified according to a distance from the viewpoint, such that a length of the character string in a vertical direction increases with a decrease in distance from the viewpoint.

The “character string to be displayed in the three-dimensional map” herein includes character strings representing information with regard to each feature (for example, the name of the feature) and other character strings, for example, geographical names, intersection names and administrative district names such as city names, ward names, town names and village names and character strings representing traffic restrictions.

The plurality of areas may be two areas, i.e., a near area and a distant area according to the distance from the viewpoint or may be three or more areas.

In a three-dimensional map, the spot farther from the viewpoint is displayed in the upper area of the image and the spot near to the viewpoint is displayed in the lower area of the image. The space for displaying a character string is thus more extended in the vertical direction on the nearer side. One embodiment of the invention increases the length of the character string displayed in the vertical direction on the nearer side, thus enabling the available space to be more effectively used for displaying the character string and improves the visibility of the character information.

The display may change over among the following three modes in accordance with one embodiment of the invention:

The first mode is to display a distant character string in the horizontal direction and displaying a near character string in the vertical direction. The display in the vertical direction means a vertically long display area for the character string. In the case of an English character string, the alphabets may be written upward or rightward.

The second mode is employed in display of a character string in the vertical direction to display a distant character string by a plurality of vertical lines and display a near character string by one vertical line. Alternatively this mode may display a near character string by a plurality of horizontal lines and display a distant character string by one horizontal line.

The third mode is the combination of the first mode and the second mode described above.

One embodiment of the invention is applicable of providing both the bird's eye view and the upward view, but is especially effective for the bird's eye view. In the bird's eye view, a relatively large area is often occupied for the background or the sky. The invention is thus advantageously applied to the bird's eye view to effectively use this area for display characters.

According to one embodiment of the three-dimensional map display device, the character display controller may change the display direction of the character string on the feature image from a horizontal direction to the vertical direction with a decrease in distance from the viewpoint.

This embodiment is not limited to an aspect of changing the display direction in two stages, i.e., the horizontal direction and the vertical direction but includes an aspect of gradually changing the display direction from the horizontal direction through an oblique direction to the vertical direction. Such gradual change allows for natural display.

According to another embodiment of the three-dimensional map display device, the character data may include feature-related character data used to display information with regard to the feature and other general character data, and the character display controller may change over the display with respect to only the feature-related character data.

The feature-related character data is closely related to the feature and has a relatively limited flexibility in display position, compared with the general character data. It is thus especially effective to change over the display with respect to the feature-related character data to an easily recognizable display mode. Changing over the display with respect to only the feature-related character data makes the display mode differ between the feature-related character data and the general character data. This advantageously facilitates discrimination between the feature-related character data and the general character data.

According to another embodiment of the three-dimensional map display device, the feature may be a building, and the feature image generator may draw the building at a height specified according to each area, irrespective of an actual height of the building.

This avoids distant buildings from being hidden by front tall buildings in a three-dimensional map looking down obliquely from above and enables the upper surfaces of all buildings to be displayed in a visible manner. This accordingly enables information with regard to all the building from the near to the distant to be displayed without any difficulty.

The invention may not necessarily include all the features described above but may be configured appropriately with partial omission or by combination of these features. The invention is not limited to the configuration of the three-dimensional map display device described above but may be configured as any of various other aspects: for example, a three-dimensional map display method; a computer program that enables the functions of the three-dimensional map display device or the three-dimensional map display method; a non-transitory storage medium in which such a computer program is stored; and a data signal that includes such a computer program and is embodied in a carrier wave. Any of various additional components described above may also be applied to any of the respective aspects.

When one embodiment of the invention is configured as a computer program or as a non-transitory storage medium in which such a computer program is stored, the configuration may include the entire program that controls the operations of the three-dimensional map display device or may include only a section that achieves the functions of the invention. Available examples of the storage medium include flexible disks, CD-ROMs, DVD-ROMs, magneto-optical disks, IC cards, ROM cartridges, punched cards, prints with barcodes or other codes printed thereon, internal storage units (memories such as RAM and ROM) and external storage units of computers and various other computer-readable media.

### BRIEF DESCRIPTION OF THE DRAWINGS

FIG. 1 is a diagram illustrating the general configuration of a navigation system according to an embodiment;

FIG. 2 is a diagram illustrating the contents of a map database 20;

FIG. 3 is a diagram illustrating a display example of shadow images and position-indicating shadow images;

FIG. 4 is a diagram illustrating the outline of character display control;

FIG. 5 is a flowchart showing a route guidance process;

FIG. 6 is a flowchart showing a driver's view display process;

FIG. 7 is a diagram illustrating a display example of the driver's view;

FIG. 8 is a first part of a flowchart showing a bird's eye view display process;

FIG. 9 is a second part of the flowchart showing the bird's eye view display process;

FIG. 10 is a diagram illustrating a display example of the bird's eye view; and

FIG. 11 is a flowchart showing a bird's eye view display process according to a modification.

### DETAILED DESCRIPTION OF EMBODIMENTS OF THE INVENTION

The following describes an embodiment of the invention in which the three-dimensional map display device is applied to a navigation system according to one aspect of the invention. Although the embodiment describes the configuration of a navigation system, the invention is not limited to this configuration but may be implemented by any of various other devices that display a three-dimensional map.

### A. System Configuration

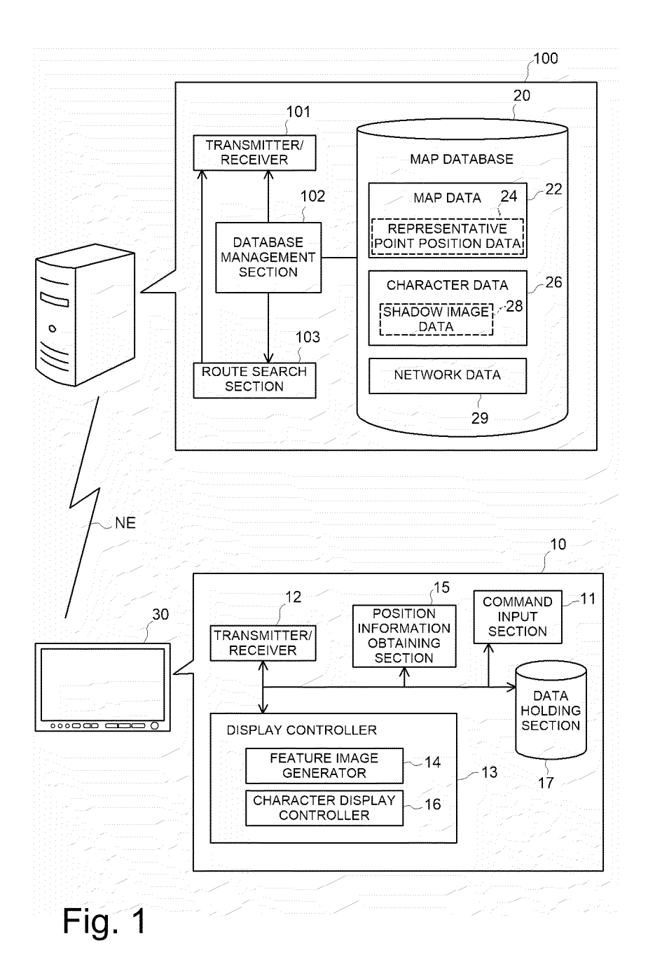

FIG. 1 is a diagram illustrating the general configuration of a navigation system according to an embodiment. The navigation system is configured by connecting a server 100 with a terminal 10 having the functions as a three-dimensional map display device by means of a network NE. Alternatively, the navigation system may be configured as a standalone device by incorporating the functions provided by the server 100 of the embodiment in the terminal 10. Otherwise the navigation system may be may be configured as a distribution system including a greater number of servers and the like than those illustrated.

The server 100 includes a map database 20 and functional blocks, a transmitter/receiver 101, a database management section 102 and a route search section 103 as illustrated. These functional blocks may be configured as software configuration by installing computer programs for implementing the respective functions in the server 100. At least part of these functional blocks may alternatively be configured as hardware configuration.

The map database 20 stores map data 22, character data 26 and network data 29. The map data 22 is data used to display a three-dimensional map during, for example, route guidance and represent the shapes of various features such as mountains, rivers, roads and buildings. Representative point position data 24 representing the position of each of these features is stored in relation to the feature. The representative point may be set arbitrarily with respect to each feature. For example, with respect to each building, the position of the center of gravity in its planar shape may be specified as the representative point.

The character data 26 is data representing character strings to be displayed in a map. According to this embodiment, each character string is displayed with a shadow, in order to give a three-dimensional appearance to the character string. Shadow image data 28 for such display is accordingly stored in relation to the character data 26. The network data 29 is data for route search that express roads as a set of links and nodes. The data structures of the map data 22 and the character data 26 will be described later.

The respective functional blocks of the server 100 provide the following functions. The transmitter/receiver 101 sends and receives various commands and data to and from the terminal 10 via the network NE. According to the embodiment, for example, commands relating to route search and map display and various data stored in the map database 20 are sent and received by the transmitter/receiver 101. The database management section 102 controls reading data from the map database 20. The route search section 103 utilizes the map database 20 to search a route from a departure place to a destination specified by the user. Any of known techniques such as Dijkstra's algorithm may be applied for the route search.

The terminal 10 includes a CPU, a ROM, a RAM and a hard disk drive. The CPU reads and executes an application program stored in the hard disk drive to serve as a transmitter/receiver 12 and a display controller 13. The display controller 13 includes a feature image generator 14 and a character display controller 16. At least part of these components may be configured by hardware.

A command input section 11 inputs the user's instructions with regard to route search and map display. The transmitter/receiver 12 sends and receives various commands and data to and from the server 100 via the network NE. A data holding section 17 temporarily holds data obtained from the server 100. A position information obtaining section 15 obtains required information for route search and route guidance, for example, the current location and the orientation of the terminal 10, by a sensor such as a GPS (global positioning system) or an electromagnetic compass.

The feature image generator 14 uses the map data 22 to draw a feature three-dimensionally by perspective projection and generate a feature image. The character display controller 16 uses the character data 26 and controls display of each character string representing information with regard to a relevant feature in the feature image. The display controller 13 controls the operations of the feature image generator 14 and the character display controller 16 and superimposes the images generated by the feature image generator 14 and the character display controller 16 to display a resulting map on a display unit 30 of the terminal 10.

### B. Map Database

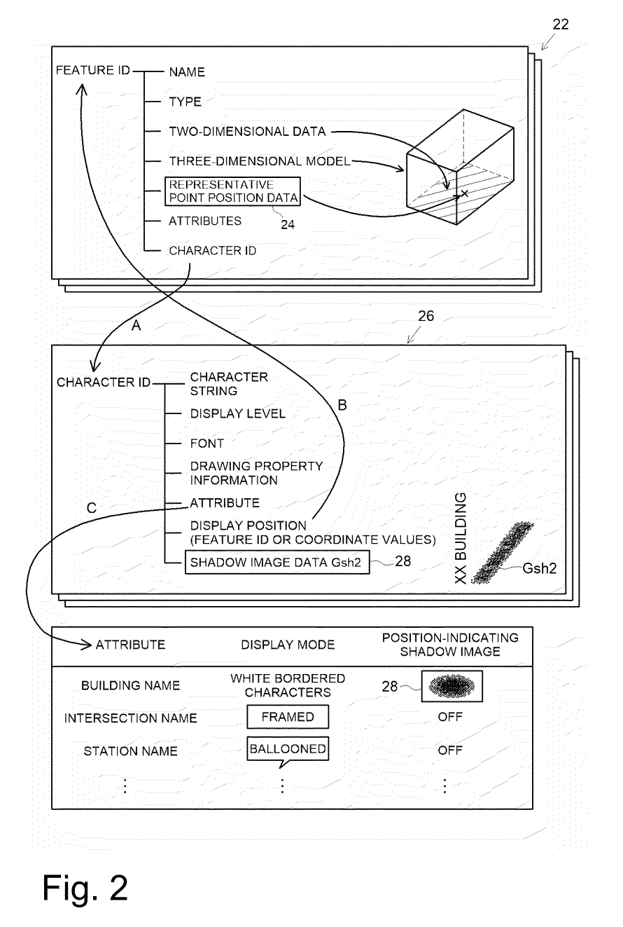

FIG. 2 is a diagram illustrating the contents of the map database 20. This specifically illustrates the structures of the map data 22 and the character data 26. In the map data 22, a unique feature ID is assigned to each feature, and various data with respect to the feature are managed under the feature ID as illustrated. “Name” shows the name of a feature. “Type” shows the type of a feature, such as “building”, “road” or “intersection”. “Two-dimensional data” is polygon data representing the planar shape of a feature. The two-dimensional data may be stored in the form of line data with respect to a linear feature such as road. In an illustrated example of “building” on the right side, shape data of a hatched area is two-dimensional data. “Three-dimensional model” is polygon data used to display each feature three-dimensionally.

The representative point position data 24 is data regarding coordinate values of a two-dimensional representative point of a feature. The representative point may be set arbitrarily with respect to each feature. According to this embodiment, the center of gravity in the two-dimensional shape of a feature is specified as the representative point of the feature.

“Attributes” are data showing various characteristics of each feature according to the type of the feature. For example, with respect to a feature “road”, attributes include the road type such as a national road or prefectural road and the number of lanes of the road. As another example, with respect to a feature “building”, attributes include the type of a building such as an office building or a house and the number of stories or the height of the building. “Character ID” is identification information for identifying a character string to be display in relation to a feature. As described below, a unique character ID is assigned to data of each character string stored in the character data 26. Specifying the character ID under the feature ID relates the data of each character string to feature data as shown by an arrow A in the illustration.

In the character data 26, a unique character ID is assigned to data of each character string, and various data with respect to the data of the character string are managed under the character ID. “Character string” shows a string of characters, for example, the name of a feature, to be displayed on the map. “Display level” is data used to control display of each character string according to the distance from the viewpoint. In the case of displaying a three-dimensional map, the user generally needs many pieces of information in the vicinity of the viewpoint, so that it is preferable to display many character strings. At a great distance from the viewpoint, however, it is preferable to display only character strings of significant importance. The data used to control display/ no display of each character string according to the distance from the viewpoint is called display level.

“Font” is data used to specify the font type for display of character strings. “Drawing property information” is data used to specify the font size and the character color for display of character strings. “Attribute” shows the content represented by each character string, such as “building name”, “intersection name” or “station name”. According to this embodiment, the display mode of each character string is changed depending on the attribute as described later.

“Display position” shows the position where each character string is to be displayed. With respect to a character string that is related to a feature, for example, a building name, a feature ID is stored as the display position. This identifies a feature in relation to each character string as shown by an arrow B in the illustration and enables the display position of the character string to be determined according to the position of the representative point of the feature. With respect to a character string that is not related to a feature, for example, an intersection name or a character representing a traffic regulation, the coordinate values where the character string is to be displayed are stored as the display position.

“Shadow image data” is texture data of shadow to be displayed with a character string in the process of displaying the character string. The texture of shadow image data is used to draw a three-dimensional map looking down obliquely from the overhead viewpoint. An example of a shadow image Gsh2 is illustrated on the right side. When a character string of “XX building” is displayed in a three-dimensional map, the shadow image Gsh2 is also displayed as if the character string is a three-dimensional object. One available method to display the shadow image Gsh2 generates a plate-like three-dimensional model with character string of “XX building” applied thereon and illuminates the three-dimensional model from an oblique direction. The procedure of the embodiment, however, provides in advance two-dimensional images as textures representing the shapes of shadows produced by lighting from an oblique direction, such as the shadow image Gsh2, and applies a texture to a character string to express a shadow in a simple way. Strictly, changing the direction of lighting changes the shape of the shadow image Gsh2. The shadow image Gsh2 is, however, displayed for the purpose of giving a three-dimensional appearance to the character string. Such strictness is accordingly not required, and the texture previously provided is sufficient for the purpose.

The shadow image Gsh2 may be common to all character strings. According to the embodiment, however, the shadow image Gsh2 is provided individually for each character string, in order to display an image reflecting the length of the character string and the content of the character string.

The character data 26 additionally stores data specifying a display mode and a position-indicating shadow image with respect to the attribute of each character string as shown by an arrow C in the illustration. In the illustrated example, with respect to the attribute “building name”, a character string is displayed as “white bordered characters” and a position-indicating shadow image is displayed along with the character string. The position-indicating shadow image is a shadow image representing a two-dimensional position of a character string displayed in a three-dimensional map. As illustrated, the position-indicating shadow image is an image like a shadow produced directly underneath when a three-dimensional model in a columnar shape with a character string applied thereon is placed in a three-dimensional space and irradiated from straight above. This position-indicating shadow image is one type of the shadow image data 28 shown in FIG. 1. The position-indicating shadow image, however, serves to indicate the two-dimensional position of the character string in addition to giving a three-dimensional appearance to the character string and is accordingly distinguished from the shadow image Gsh2 described above. The position-indicating shadow image may be provided as an individual texture for each character string. The embodiment, however, provides the position-indicating shadow image as a common texture to the attribute “building name”, which advantageously saves the data volume of the texture.

The use or no use of the position-indicating shadow image is also controlled according to the attribute of the character string. In the illustrated example, with respect to the attribute “intersection name”, the display mode is framed characters and the position-indicating shadow image is not used. With respect to the attribute “station name”, the display mode is ballooned characters and the position-indicating shadow image is not used. Alternatively the position-indicating shadow image may also be used with respect to the attribute other than the building name. The texture of the position-indicating shadow image used for the attribute other than the building name may be different from the texture used for the building name.

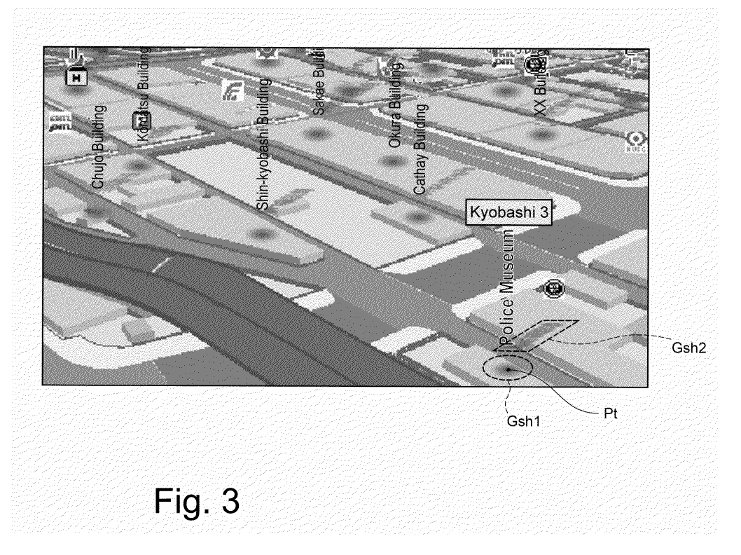

FIG. 3 is a diagram illustrating a display example of shadow images and position-indicating shadow images. The illustration is an enlarged part of a three-dimensional map displayed according to the embodiment. With respect to a character string “Police Museum” on the lower right side of the illustration, a shadow image Gsh1 in an elliptical shape is displayed to show a two-dimensional position Pt of the character string, i.e., the representative point of a building of police museum. This is an example of the position-indicating shadow image described above. A shadow image Gsh2 in a parallelogram or trapezoidal shape is displayed obliquely down the character string as if the character string is projected on the ground surface. This is an example of the shadow image Gsh2 described above. With respect to the character string “Police Museum” having the attribute “building name”, this embodiment displays both the shadow image Gsh2 and the position-indicating shadow image Gsh1 to give a three-dimensional appearance to the character string and indicate the two-dimensional position of the character string.

In the case of displaying each character string in a three-dimensional map, it is often difficult to understand which feature the character string is related to and which point the character string is two-dimensionally related to. This is because each point in a projected image in the three-dimensional map does not unequivocally represent one point in the three-dimensional space. This embodiment, however, displays the position-indicating shadow image Gsh1 in relation to each character string, so as to facilitate understanding the two-dimensional position which the character string is related to. This method takes advantage of the user's sensory experience that a shadow is produced immediately below an object. Such sensory experience enables the user to automatically relate the position-indicating shadow image Gsh1 to the character string without any leading line. Accordingly the embodiment uses the position-indicating shadow image Gsh1 to enable the user to readily understand the relationship between a character string and a two-dimensional position and thereby the relationship between a character string and a feature, with avoiding the complexity of the resulting map.

The embodiment displays a character string in the vertical direction, along with the position-indicating shadow image Gsh1 as illustrated in FIG. 3. Displaying a character string in the horizontal direction reminds the user of a plate-like object and causes the corresponding position-indicating shadow image Gsh1 to be a horizontally long image of a relatively large area. Displaying a character string in the vertical direction, on the other hand, reminds the user of a columnar three-dimensional object and thereby reduces the area of the position-indicating shadow image Gsh1. Using the position-indicating shadow image Gsh1 in combination with a character string displayed in the vertical direction has the advantage of more distinctly indicating the two-dimensional position of the character string.

### C. Outline of Character Display Control

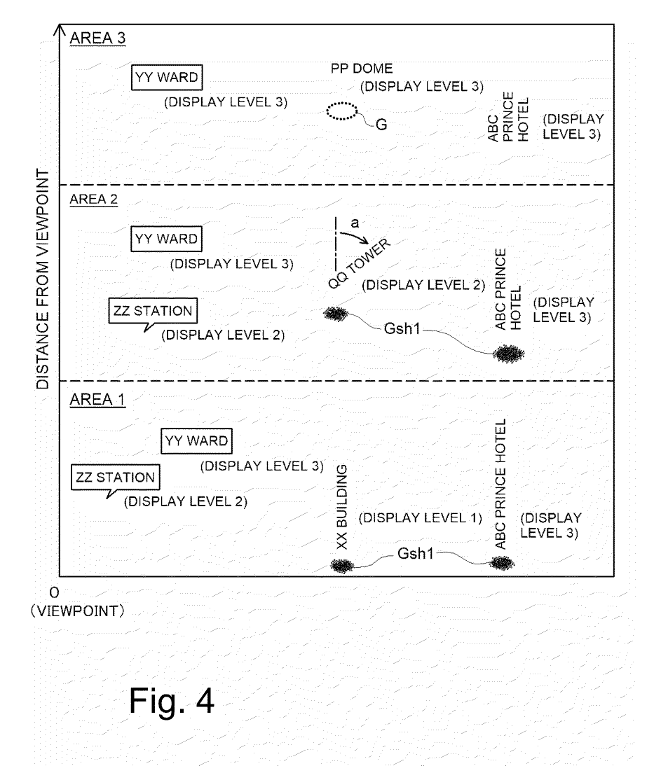

FIG. 4 is a diagram illustrating the outline of character display control. The embodiment changes over the display/no display of each character string and the display direction of the character string according to the distance from the viewpoint position in display of a three-dimensional map. In the illustrated example, character display control is performed with respect to each of three areas, area 1, area 2 and area 3 divided according to the distance from the viewpoint in the ascending order. The distance of each area from the viewpoint may be determined arbitrarily. The number of divisional areas may also be set arbitrarily and may be, for example, two areas or four or more areas.

The display control described below is applied to only character strings having the attribute “building name” according to the embodiment but is also applicable to character strings having other attributes.

The description first regards control of the display/no display of character strings. The embodiment sets the display/no display of character strings with respect to each area. As described previously with reference to FIG. 2, the display level is set for data of each character string in the character data 26. The embodiment displays only character strings having a display level “3” in the most distant area 3 from the viewpoint. In the area 2, character strings having the display level of not less than “2”, i.e., character strings having the display level “2” or the display level “3” are displayed. In the area 1 nearest to the viewpoint, character strings having the display level of not less than “1”, i.e., character strings having any of the display levels “1” to “3” are displayed. In the illustrated example, the display level “3” is set for a character string “YY Ward” as shown in the left-side column of the illustration, so that this character string “YY Ward” is displayed in all the areas 1 to 3. The display level “2” is set for a character string “ZZ Station”, so that this character string “ZZ Station” is displayed in the area 1 and the area 2 but is not displayed in the area 3. The display level “1” is set for a character string “XX Building”, so that this character string “XX Building” is displayed only in the area 1. The display level of the greater value means the character strings to be displayed even at the greater distance from the viewpoint, i.e., the character strings of the greater importance.

The embodiment controls the display direction and the number of display lines of each character string with respect to each area divided by the distance from the viewpoint. When a building name, for example, “XX Building”, is displayed in the area 1 as shown in the center column of the illustration, the building name is displayed in the vertical direction, along with the position-indicating shadow image Gsh1. This corresponds to the display illustrated in FIG. 3.

When a building name, for example, “QQ Tower”, is displayed in the area 2, the building name is displayed obliquely to the vertical direction by an angle “a” degrees. The position-indicating shadow image Gsh1 is displayed immediately below the character string, as in the area a1. The angle of inclination “a” degrees may be determined arbitrarily by taking into account the readability of a character string.

When a building name, for example, “PP Dome” is displayed in the area 3, the building name is displayed in the horizontal direction. At the position farther from the viewpoint as in the area 3, there is often a narrow extra space above a feature and the space may not be sufficient for displaying a character string in the vertical direction. In the area 3, the position-indicating shadow image Gsh1 is not displayed (broken line area G in the illustration). In the area 3 farther from the viewpoint, a feature itself is displayed in a relatively small size. Accordingly, displaying the position-indicating shadow image Gsh1 does not clearly relate a character string to a feature. Displaying the position-indicating shadow image Gsh1 with respect to a feature displayed in a small size may make even the feature itself invisible.

As described above, each character string is displayed in the horizontal direction at the position farther from the viewpoint, and the display direction is changed to the vertical direction that sufficiently uses the space in the vertical direction, at the position nearer to the viewpoint. This effectively uses the space in the image of a three-dimensional map and allows for clear display of a character string.

Such character display control may change the number of display lines of a character string, in addition to the display direction of the character string.

For example, as shown in the right-side column of the illustration, a character string “ABC PRINCE HOTEL” is displayed in one line in the area 1, is displayed in two lines as “ABC PRINCE” “HOTEL” in the area 2 and is displayed in three lines AS “ABC” “PRINCE” “HOTEL” in the area 3. Changing the number of display lines in this manner enables a character string to be displayed in the shorter length in the vertical direction at the position farther from the viewpoint and in the longer length in the vertical direction at the position nearer to the viewpoint.

The display control may selectively change the display direction and the number of display lines of each character string according to the language, for example, English writing or Japanese writing. The display control may change only either the display direction or the number of display lines.

### D. Route Guidance Process

The following describes display control of a three-dimensional map according to the embodiment in which the navigation system performs route search and route guidance.

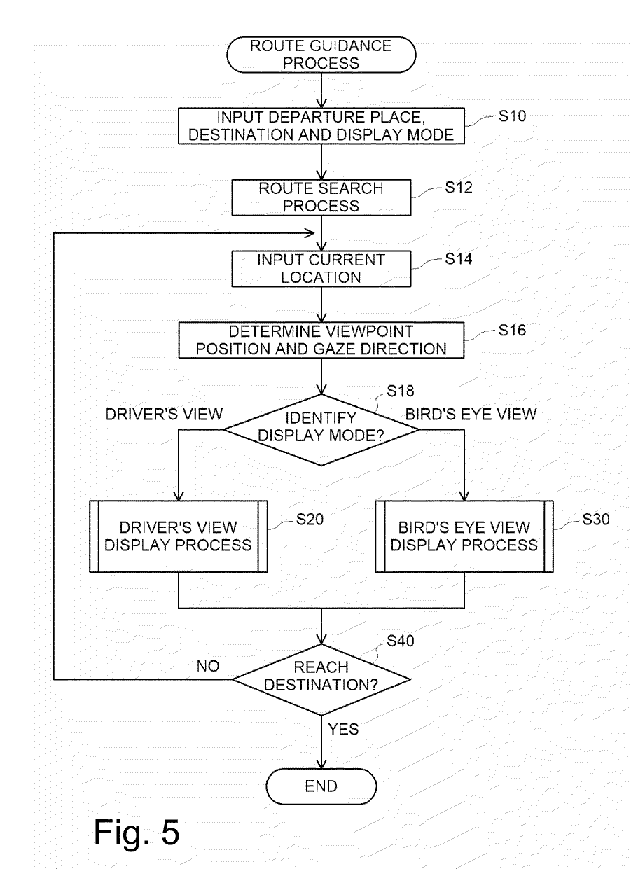

FIG. 5 is a flowchart showing a route guidance process. The terminal 10 and the server 100 cooperatively perform this route guidance process, although not illustrated in a distinct manner.

When the process starts, the navigation system inputs the user's specifications with regard to a departure place, a destination and a display mode (step S10). The current location may be specified as the departure place. According to the embodiment, two display modes are provided: upward view display mode looking up from the driver's viewpoint relatively near to the ground surface (hereinafter referred to as driver's view) and bird's eye view display mode looking down from the viewpoint at the height (hereinafter referred to as bird's eye view).

The navigation system performs a route search process based on the user's specifications (step S12). This process uses the network data 29 stored in the map database 20 and may employ any of known techniques such as Dijkstra's algorithm. The searched route is sent to the terminal 10.

The terminal 10 receives the result of route search and performs route guidance by the following procedure, while displaying a three-dimensional map. The terminal 10 inputs the current location from a sensor such as GPS (step S14) and determines the viewpoint position and the gaze direction for displaying a three-dimensional map (step S16). The gaze direction may be, for example, a direction looking at a future position on the route from the current location to the destination. The viewpoint position may be behind the current location by a predetermined distance. The viewpoint position may be set at a height relatively near to the ground surface with respect to the driver's view, and may be set at a height looking down with respect to the bird's eye view. The height of the viewpoint in either of the display modes and the looking-down angle in the bird's eye view may be adjusted arbitrarily by the user.

The terminal 10 identifies the display mode specified by the user (step S18) and performs a driver's view display process (step S20) upon specification of the driver's view and performs a bird's eye view display process (step S30) upon specification of the bird's eye view. The driver's view display process and the bird's eye view display process are performed to display a three-dimensional map in the respective display modes. The details of the driver's view display process and the bird's eye view display process are described below. The terminal 10 repeatedly performs the processing of steps S14 to S30 until reaching the destination (step S40).

### D1. Driver's View Display Process

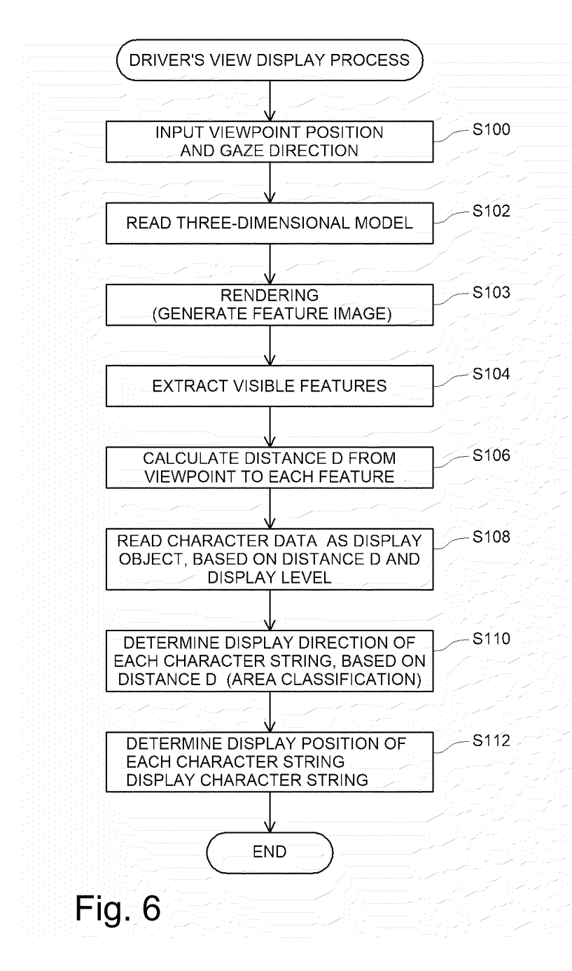

FIG. 6 is a flowchart showing the driver's view display process. This process corresponds to step S20 in the route guidance process (FIG. 5) and is performed by the terminal 10.

When the process starts, the terminal 10 inputs the viewpoint position and the gaze direction (step S100) and reads a three-dimensional model from the map database 20 (step S102). The terminal 10 then performs rendering by perspective projection based on the input viewpoint position and gaze direction and generates a feature image in which features are drawn three-dimensionally (step S103).

The terminal 10 subsequently shifts the process flow to a process of displaying character strings on the feature image. The terminal 10 extracts each feature displayed in the feature image, i.e., each feature visible from the viewpoint position (step S104) and calculates a distance D from the viewpoint position to each feature (step S106).

The terminal 10 subsequently reads character data as the display object, based on the distance D and the display level (step S108). Calculation of the distance D from the viewpoint position to a feature identifies which of the areas shown in FIG. 4 the feature belongs to. Referring to the display level set for character data related to each feature determines the display/no display of the character string. Character data of character strings to be displayed are then sequentially extracted.

After extraction of character strings as the display object, the terminal 10 determines the display direction of each character string, based on the distance D, i.e., area classification (step S110). As described above with reference to FIG. 4, the embodiment changes the display direction with regard to only character strings having the attribute “building name”. The processing of step S110 may thus be skipped with respect to character strings having attributes other than “building name” as the display object. With respect to each character string having the attribute “building name”, the display direction of the character string, i.e., vertical direction, oblique direction or horizontal direction, is determined according to the distance D or the area classification. The number of display lines may also be determined with respect to each character string.

The terminal 10 determines the display position of each character string and displays the character string to be superimposed on the feature image (step S112). The display position of each character string may be determined by any of various methods. The embodiment determines the display position of each character string by a two-dimensional process in the feature image generated at step S103. More specifically, the procedure identifies an area where a feature related to each character string is displayed (hereinafter referred to as “feature area”) in the feature image and determines the display position of the character string in the feature image, based on the positional relationship of the character string to the feature area. For example, with respect to a character string displayed in the vertical direction, the display position may be determined to have a large overlap between the character string and the feature area. With respect to a character string displayed in the horizontal direction, the display position may be determined to be above the feature area.

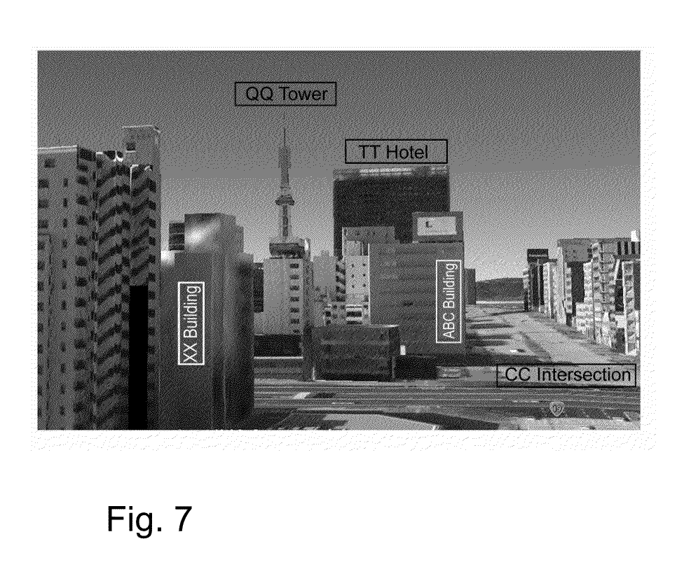

FIG. 7 is a diagram illustrating a display example of the driver's view. As illustrated, features are drawn three-dimensionally from the relatively low viewpoint. With respect to features located in an area near to the viewpoint position, building names are displayed in the vertical direction, for example, “XX Building” and “ABC Building”. With respect to features located in an area farther from the viewpoint position, building names are displayed in the horizontal direction, for example, “QQ Tower” and “TT Hotel”.

A character string other than building name, for example, “CC Intersection”, is excluded from the control object of the display direction and is accordingly displayed in the horizontal direction even when the intersection is located in the area near to the viewpoint position.

### D2. Bird's Eye View Display Process

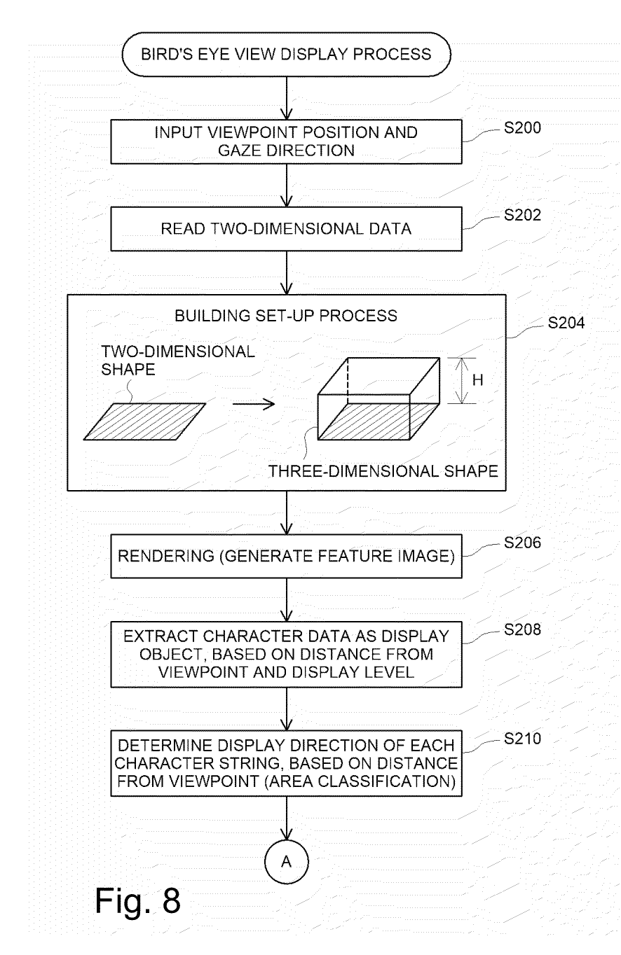

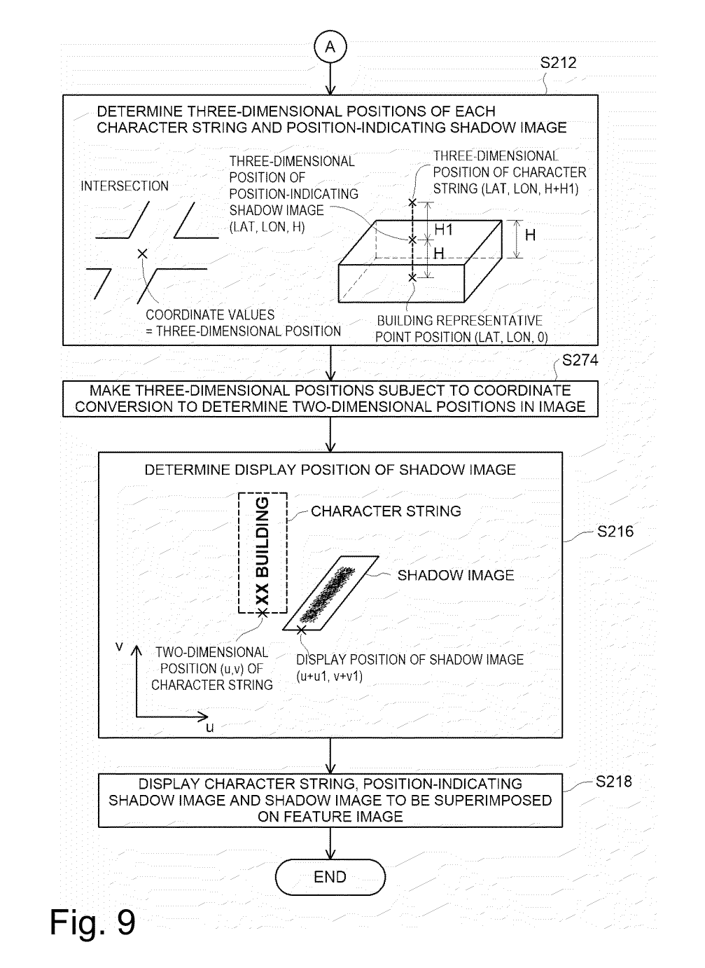

FIGS. 8 and 9 are flowcharts showing the bird's eye view display process. This process corresponds to step S30 in the route guidance process (FIG. 5) and is performed by the terminal 10.

When the process starts, the terminal 10 inputs the viewpoint position and the gaze direction (step S200) and reads two-dimensional data from the map database 20 (step S202). The birds eye view display process may also read a three-dimensional model and perform rendering by perspective projection. The embodiment, however, places importance on the functions as a map and intentionally uses two-dimensional data to allow for display in a mode that facilitates understanding of the positional relationship of features.

The terminal 10 then uses the two-dimensional data to perform a building set-up process (step S204). The outline of this process is illustrated. The left-side drawing shows a polygon of a building expressed by two-dimensional data. The terminal 10 translates this polygon shape in the height direction by a predetermined height H to generate a three-dimensional shape as shown by the right-side drawing. The height H is determined in advance, irrespective of the actual height of the building. In the bird's eye view, all the buildings are thus three-dimensionally displayed by the fixed height H. For the three-dimensional display, a three-dimensional model of the height H may be provided in advance, instead of the set-up process of the two-dimensional data.

Adjustment of the heights of buildings to the fixed value H is attributed to the following reason. In a three-dimensional map, displaying the buildings three-dimensionally may cause some roads and buildings to be hidden by tall buildings and lead to the lack of important geographical information as the map. Displaying the buildings in two-dimensional shapes, however, does not give a three-dimensional appearance and makes it difficult for the user to intuitively recognize the presence of the buildings. This reduces the benefit of the three-dimensional map that facilitates intuitively understanding geography. In order to avoid such a potential problem, the embodiment displays each building three-dimensionally, with restricting the height of the building to such an extent that does not hide other buildings and roads (FIG. 3).

For this purpose, the height H may be set arbitrarily between a lower limit value that gives a three-dimensional appearance and an upper limit value that does not hide other buildings and roads. By taking into account the difficulty in feeling the three-dimensional appearance with an increase in looking-down angle (closer to the vertical direction) in the bird's eye view, the height H may be increased with an increase in looking-down angle in the birds eye view.

Although the height H is fixed to a certain value over the entire area according to the embodiment, the height H may be changed according to the distance from the viewpoint. For example, the height H may be decreased with an increase in distance from the viewpoint and may be set to zero at a great distance. Features are displayed in small sizes at a great distance, so that the three-dimensional appearance is of less importance. Setting the height H to zero at a great distance advantageously reduces the processing load. Upon completion of the building set-up process, the terminal 10 performs rendering by perspective projection and generates a feature image in which features are drawn three-dimensionally (step S206).

The terminal 10 then shifts the process flow to a process of displaying character strings on the feature image. The terminal 10 extracts character data as the display object, based on the distance D from the viewpoint and the display level (step S208) and determines the display direction of each character string, based on the distance from the viewpoint, i.e., area classification (step S210). This process is identical with the process performed in the driver's view display process.

The process flow then goes to FIG. 9. The terminal 10 determines the three-dimensional positions of each character string and its position-indicating shadow image Gsh1, i.e., their display positions in the three-dimensional space (step S212). The procedure of determining the three-dimensional positions is illustrated.

With respect to a character string that is not related to a feature, for example, an intersection, i.e., with respect to a character string having coordinate values stored as the display position in the character data 26 (FIG. 2), the coordinate values are used as the three-dimensional position of the character string. The position-indicating shadow image Gsh1 is not displayed with respect to a character string having the attribute other than “building name”, so that there is no need to determine the three-dimensional position of the position-indicating shadow image Gsh1.

With respect to a character string having the attribute “building name”, on the other hand, the terminal 10 refers to the feature ID stored as the display position in the character data 26 (FIG. 2) and obtains the position of the representative point of a feature related to the character string. In the illustrated example, a building representative point position (LAT, LON, 0) is obtained. The representative point position is given by two-dimensional coordinates (LAT, LON) and is changed to the three-dimensional coordinates by adding the height set equal to zero.

The position-indicating shadow image Gsh1 is displayed on the upper surface of the feature according to the embodiment. The display position is accordingly specified by increasing the height value of the building representative point position (LAT, LON, 0) by the height H used in the building set-up process. Accordingly the three-dimensional position of the position-indicating shadow image Gsh1 is set as (LAT, LON, H).

The character string is displayed as if floating above the building. The position above the height H of the building by an increment H1 is set as the lower edge of the character string. The three-dimensional position of the character string is accordingly set as (LAT, LON, H+H1). The increment H1 may be set arbitrarily by taking into account the appearance.

As described above, the embodiment determines the display positions of the position-indicating shadow image Gsh1 and the character string, so as to display the position-indicating shadow image Gsh1 and the character string immediately above the building representative point position. As long as the position-indicating shadow image Gsh1 and the character string are displayed at the positions that allow the user to readily recognize the relationship to the building, their display positions may be slightly displaced from the building representative point position. For example, the display positions of the position-indicating shadow image Gsh1 and the character string may be displaced in such a range that the building representative point position is included in the position-indicating shadow image Gsh1. Even when the building representative point is set near to the borderline of the building, such positional displacement prevents the display of the position-indicating shadow image Gsh1 from being protruded from the upper surface of the building, so as to reduce a feeling of strangeness in the display.

After determining the three-dimensional positions of the character string and the position-indicating shadow image Gsh1, the terminal 10 makes their three-dimensional positions subjected to coordinate conversion by perspective projection in the same manner as the feature, and determines their two-dimensional positions in a projected image, i.e., the display positions as two-dimensional coordinates in the projected image (step S214).

The terminal 10 subsequently determines the display position of the shadow image Gsh2 (step S216). The shadow image Gsh2 is a texture, i.e., a two-dimensional image displayed to give a three-dimensional appearance to the character string. The display position of the shadow image Gsh2 is thus determined two-dimensionally, based on the relationship to the two-dimensional position of the character string. A procedure of determining the display position of the shadow image Gsh2 is illustrated. It is here assumed that two-dimensional coordinates are expressed as u and v in the projected image.

When the display position of a character string is specified by a two-dimensional position (u,v), the display position of the shadow image Gsh2 is a position displaced by u1 and v1 from the two-dimensional position in the projected image. The display position of the shadow image Gsh2 is accordingly set as (u+u1, v+v1). The relative displacements u1 and v1 may be set arbitrarily by taking into account the appearance. The relative displacements u1 and v1 are common to all character strings according to the embodiment, but may be changed according to each character string or according to each attribute of the character string.

After determining the display positions of the character string, the position-indicating shadow image Gsh1 and the shadow image Gsh2, the terminal 10 displays the character string, the position-indicating shadow image Gsh1 and the shadow image Gsh2 to be superimposed on the feature image to complete a three-dimensional map (step S218).

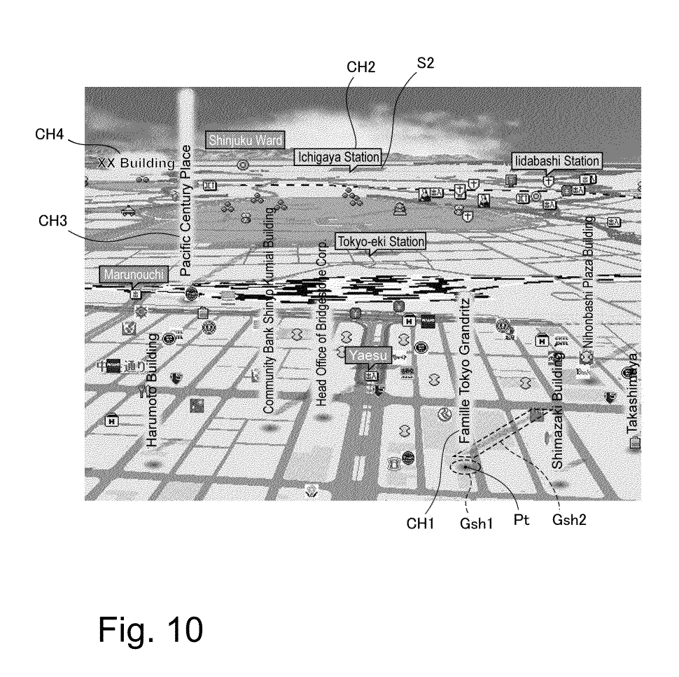

FIG. 10 is a diagram illustrating a display example in the bird's eye view. In the bird's eye view, the respective buildings are drawn at the uniform height, irrespective of the actual heights. In the area relatively near to the viewpoint, character strings representing the names of buildings are displayed in the vertical direction, like character strings CH1 and CH3. Displaying the character string in the vertical direction allows for the effective use of the sky area and enables the character string to be displayed in an easily recognizable manner, as in the case of the character string CH3.

The display positions of these character strings are above the corresponding buildings. With respect to the character string CH1, the position-indicating shadow image Gsh1 is displayed at the position Pt immediately above the representative point position on the upper surface of the building, and the shadow image Gsh2 is also displayed to give a three-dimensional appearance to the character string.

According to the embodiment, the building names are displayed in the horizontal direction at a great distance from the viewpoint. In the illustrated map of FIG. 10, the display mode of the building name is changed to the display in the horizontal direction in the area farther from the viewpoint, like a character string CH4. The position-indicating shadow image Gsh1 is not displayed.

With respect to a character string other than the building name, for example, a station name, like a character string CH2, the character string is displayed in a display mode of ballooned and framed characters differently from the building name (FIG. 2). With respect to a character string having the attribute other than the building name, the position-indicating shadow image Gsh1 is not displayed. A shadow image like a shadow image S2 is, however, displayed to give a three-dimensional appearance to the character string.

As described above, the navigation system of the embodiment displays each character string above a relevant feature, along with the position-indicating shadow image Gsh1 indicating the position of the character string in the case of displaying a three-dimensional map in the bird's eye view. This clarifies the relationship between each character string and a relevant feature and provides an easily-recognizable three-dimensional map with suppressing reduction in reality of the three-dimensional map and avoiding the complexity of the map.

The embodiment provides the position-indicating shadow image Gsh1 and the shadow image Gsh2 in advance as textures and accordingly eliminates the need to generate the position-indicating shadow image Gsh1 and the shadow image Gsh2 by complicated calculation using the lighting technique in CG (computer graphics). This enhances the processing speed in display of the position-indicating shadow image Gsh1 and the shadow image Gsh2 on the feature image. The display sizes and the display shapes of the position-indicating shadow image Gsh1 and the shadow image Gsh2 may be changed according to the length and the attribute of the relevant character string. With respect to a shadow image in a relatively simple shape such as the position-indicating shadow image Gsh1, the position-indicating shadow image Gsh1 may be generated from a geometric shape such as an elliptical shape, at the time of display.

The embodiment draws building at the uniform height, irrespective of the actual heights of the buildings in the bird's eye view. In the bird's eye view, this prevents buildings and roads farther from the viewpoint from being hidden by buildings near to the viewpoint to suppress the lack of information as the map, while giving a three-dimensional appearance to the buildings.

The embodiment changes the display direction of each character string such as to be displayed in the vertical direction in the area relatively near to the viewpoint and to be displayed in the horizontal direction in the distant area, both in the driver's view and in the bird's eye view. The display is accordingly controlled to increase the length of a character string in the vertical direction at the position nearer to the viewpoint. This allows for the effective use of the space, for example, the background area like the sky, in a three-dimensional map in the area near to the viewpoint and thereby enables character strings to be displayed in an easily recognizable manner.

### E. Modifications

The foregoing describes some aspects of the invention. The present invention is, however, not limited to these aspects but may be implemented by various other aspects within the scope of the invention. Some examples of possible modifications are given below.

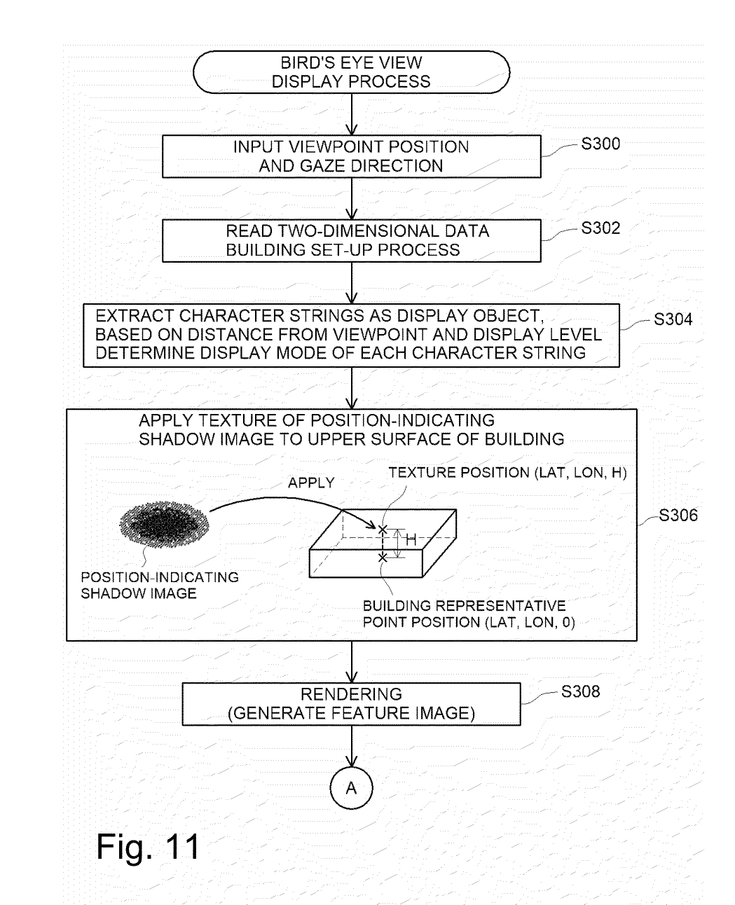

FIG. 11 is a flowchart showing a bird's eye view display process according to a modification. This process is performed, in place of the process of the embodiment (FIG. 8) described above.

In the process according to the modification, like the process of the embodiment, the terminal 10 inputs the viewpoint position and the gaze direction (step S300) and reads two-dimensional data and performs a building set-up process (step S302). The terminal 10 subsequently extracts character strings as the display object, based on the distance from the viewpoint and the display level and determines the display mode of each character string (step S304). This process identifies character strings to be displayed with position-indicating shadow images Gsh1, among character strings having the attribute “building name”.

According to the modification, the terminal 10 applies the texture of the position-indicating shadow image Gsh1 on the upper surface of each building (step S306). The outline of this process is illustrated. The texture of the position-indicating shadow image Gsh1 is stored in the character data 26 (FIG. 2), like the embodiment. The process of the modification applies the texture on the upper surface of a three-dimensional polygon representing the building generated by the building set-up process in the three-dimensional space. The position where the texture is applied is immediately above the building representative point position (LAT, LON, 0), like the above embodiment. In other words, the texture position is specified as (LAT, LON, H), and the texture is applied such that the center of gravity of the texture image matches the texture position.

The terminal 10 performs rendering by perspective projection in this state to generate a feature image (step S308). This generates a feature image in which the position-indicating display images Gsh1 are already displayed. After step 5308, the process flow follows the process of the embodiment (FIG. 9) to determine the display positions of each character string and its shadow image Gsh2 and display the character and the shadow image Gsh2 to be superimposed on the feature image (steps S212 to 5218 in FIG. 9). The modification, however, omits the processing with respect to the position-indicating shadow image Gsh1 from the process of the embodiment.

The process of this modification displays a three-dimensional map similar to the three-dimensional map displayed by the process of the embodiment.

According to another modification, the character string and the position-indicating shadow image Gsh1 may be displayed on the feature image to sway above and on the upper surface of the relevant feature. The embodiment describes the application of the invention to the navigation system, but the invention may be configured as a device that displays a three-dimensional map irrespective of route search and route guidance functions.

The invention is applicable to technology of displaying a feature along with a character string representing information with regard to the feature, in a three-dimensional map in which features are expressed three-dimensionally.

What is claimed is:

1. A three-dimensional map display device for displaying a three-dimensional map in which features are expressed three-dimensionally, the three-dimensional map display device comprising:
a map database that stores map data used to display each feature three-dimensionally, in relation to character data representing a character string to be displayed in the three-dimensional map;
a feature image generator that uses the map data to generate a feature image by perspective projection of each feature from a specified viewpoint; and
a character display controller that uses the character data to control display of the character string on the feature image, wherein
the character display controller changes over at least one of a display direction and a number of display lines of the character string with respect to each of a plurality of areas in the feature image specified according to a distance from the viewpoint, such that a length of the character string in a vertical direction increases with a decrease in distance from the viewpoint.

2. The three-dimensional map display device according to claim 1, wherein
the character display controller changes the display direction of the character string on the feature image from a horizontal direction to the vertical direction with a decrease in distance from the viewpoint.

3. The three-dimensional map display device according to claim 2, wherein
the character data include feature-related character data used to display information with regard to the feature and other general character data, and the character display controller changes over the display with respect to only the feature-related character data.

4. The three-dimensional map display device according to claim 3, wherein
the feature is a building, and
the feature image generator draws the building at a height specified according to each area, irrespective of an actual height of the building.

5. The three-dimensional map display device according to claim 2, wherein
the feature is a building, and
the feature image generator draws the building at a height specified according to each area, irrespective of an actual height of the building.

6. The three-dimensional map display device according to claim 1, wherein
the character data include feature-related character data used to display information with regard to the feature and other general character data, and
the character display controller changes over the display with respect to only the feature-related character data.

7. The three-dimensional map display device according to claim 1, wherein
the feature is a building, and
the feature image generator draws the building at a height specified according to each area, irrespective of an actual height of the building.

8. A three-dimensional map display method performed by a computer to display a three-dimensional map, in which features are expressed three-dimensionally, the three-dimensional map display method comprising:
obtaining map data and character data from a map database which stores the map data used to display each feature three-dimensionally, in relation to the character data representing a character string to be displayed in the three-dimensional map;
using the map data to generate a feature image by perspective projection of each feature from a specified viewpoint; and
using the character data to control display of the character string on the feature image, wherein
the using the character data to control the display changes over at least one of a display direction and a number of display lines of the character string with respect to each of a plurality of areas in the feature image specified according to a distance from the viewpoint, such that a length of the character string in a vertical direction increases with a decrease in distance from the viewpoint.

9. A computer readable media storing a computer program that causes a computer to display a three-dimensional map, in which features are expressed three-dimensionally, the computer program causing the computer to implement:
a data obtaining function of obtaining map data and character data from a map database which stores the map data used to display each feature three-dimensionally, in relation to the character data representing a character string to be displayed in the three-dimensional map;
a feature image generating function of using the map data to generate a feature image by perspective projection of each feature from a specified viewpoint; and
a character display control function of using the character data to control display of the character string on the feature image, wherein
the character display control function comprises a display mode changeover function of changing over at least one of a display direction and a number of display lines of the character string with respect to each of a plurality of areas in the feature image specified according to a distance from the viewpoint, such that a length of the character string in a vertical direction increases with a decrease in distance from the viewpoint.
